(19) United States
(12) Patent Application Publication
(10) Pub. No.: US 2014/0200399 A1
(43) Pub. Date: Jul. 17, 2014

(54) EROTIC TOY

(71) Applicant: ?JEP! NAAMLOZE VENOOTSCHAP, Drongen (BE)

(72) Inventor: Eric Fernand Louis VANDAELE, Wingene (BE)

(73) Assignee: ?JEP! NAAMLOZE VENOOTSCHAP, Drongen (BE)

(21) Appl. No.: 13/850,766

(22) Filed: Mar. 26, 2013

(30) Foreign Application Priority Data
Jan. 14, 2013 (BE) 2013/0021

(51) Int. Cl. A61H 19/00

(52) U.S. Cl. CPC A61H 19/30
USPC 600/38

(57) ABSTRACT

Erotic toy for stimulating erogenous zones of the body, consisting of a hollow, waterproof housing in the shape of a heart with convex surfaces that floats in water, equipped with a vibrator and internal lighting whereby the vibrations of the vibrator can be continuous or pulsed.

The present invention relates to a toy for romantic and erotic applications.

More specifically, the invention is intended for creating a romantic atmosphere and for stimulating erogenous zones of the body.

It is known that to stimulate erogenous zones of the body a vibrator can be used, which can generate a vibrating movement that can have a stimulating effect on the erogenous zones of the body.

Traditionally such vibrators are available in all kinds of forms and dimensions, whereby generally the form of a male genital organ is imitated.

Often the vibration speed and type can be set to one of the possible speeds and types associated with the model of vibrator in question.

A disadvantage of these known vibrators is that they are generally not water resistant, and as such are not suitable for use in a damp room such as a bathroom or shower cubicle.

Another disadvantage of these known vibrators is that they are heavier than water such that they sink to the bottom if they lie or get into water.

Another disadvantage of existing vibrators is that the vibration is constant at a certain speed or can only be set to different speeds in discrete steps.

Another disadvantage of existing vibrators is that they cannot be carried discretely because their shape is revealing.

The purpose of the present invention is to provide a solution to the aforementioned and other disadvantages, by providing a combination of a romantic and an erotic toy for stimulating the erogenous zones of the body, consisting of a hollow, waterproof housing in the shape of a heart with convex surfaces that floats in water, equipped with a vibrator and internal lighting whereby the vibrations of the vibrator can be constant or pulsed, even in the form of a heartbeat simulation.

An advantage of this erotic toy is that its shape is concealing and can be carried or displayed discretely.

Another advantage is that its external shape is pleasing and decorative and can be lit from the inside, such that the toy has atmosphere-creating properties and can also be used just for this purpose.

An additional advantage is that the toy is water resistant and floats in water, such that it can float in a bath filled with water for example, between any bath foam and thereby can create a romantic red glow in the bathroom to support a romantic atmosphere.

A particular advantage is that the toy has a vibration function whereby the vibration can be set constant or pulsed, in order to stimulate the erogenous zones of the body.

Preferably the vibrations of the vibrator are pulsed with a double pulse, whose rhythm corresponds to the two heart sounds (diastolic and systolic) of a fictitious regular beating heart.

An advantage of such a double vibration pulse is that the vibration at the rhythm of a heart beat has a stimulating effect on the blood circulation in erogenous zones, which results in an improved blood supply and enhanced erotic sensitivity.

Preferably the internal lighting can be set to continuous or flashing, and the hollow housing is manufactured from a matt red coloured plastic that is translucent.

An advantage of such lighting in the erotic toy is that the internal lighting further accentuates the red colour of the heart-shaped toy, such that the toy also has atmosphere-creating properties.

Preferably the internal lighting consists of one or more LED lights.

An advantage of LED lights is that they are small, have low electricity consumption and a very long lifetime, such that normally they never have to be replaced during the lifetime of the toy.

Preferably the erotic toy has a rechargeable battery that can be charged from an external electricity source and which acts as a power source for the built-in vibrator motor and the lighting of the toy.

An advantage of such a built-in rechargeable battery is that the user never has to replace the batteries in the toy.

The toy has a watertight closable connector to which a USB cable can be connected whose USB connector can be connected to a USB port on a personal computer, or another power source such as a USB port on a transformer that can be connected to the public electricity grid.

An advantage of these connection facilities is that the user can charge his toy anywhere, just like a mobile telephone and thus also in a car if desired.

With the intention of better showing the characteristics of the invention, a preferred embodiment of the erotic toy according to the invention is described hereinafter, by way of an example without any limiting nature, with reference to the accompanying drawings, wherein:

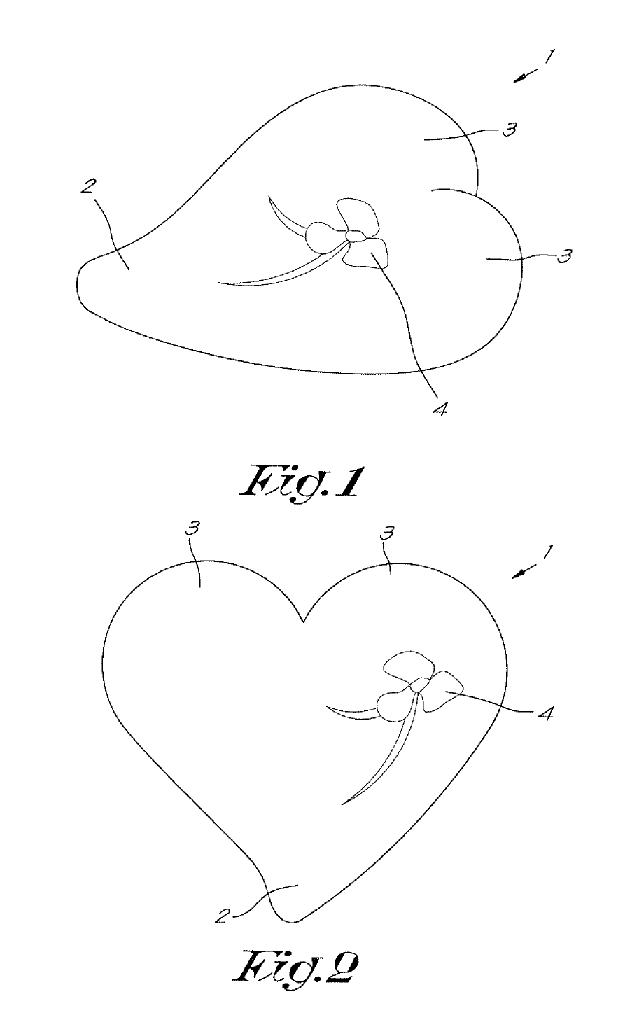

FIG. 1 schematically shows in perspective an erotic toy according to the invention;

FIG. 2 shows the front of FIG. 1;

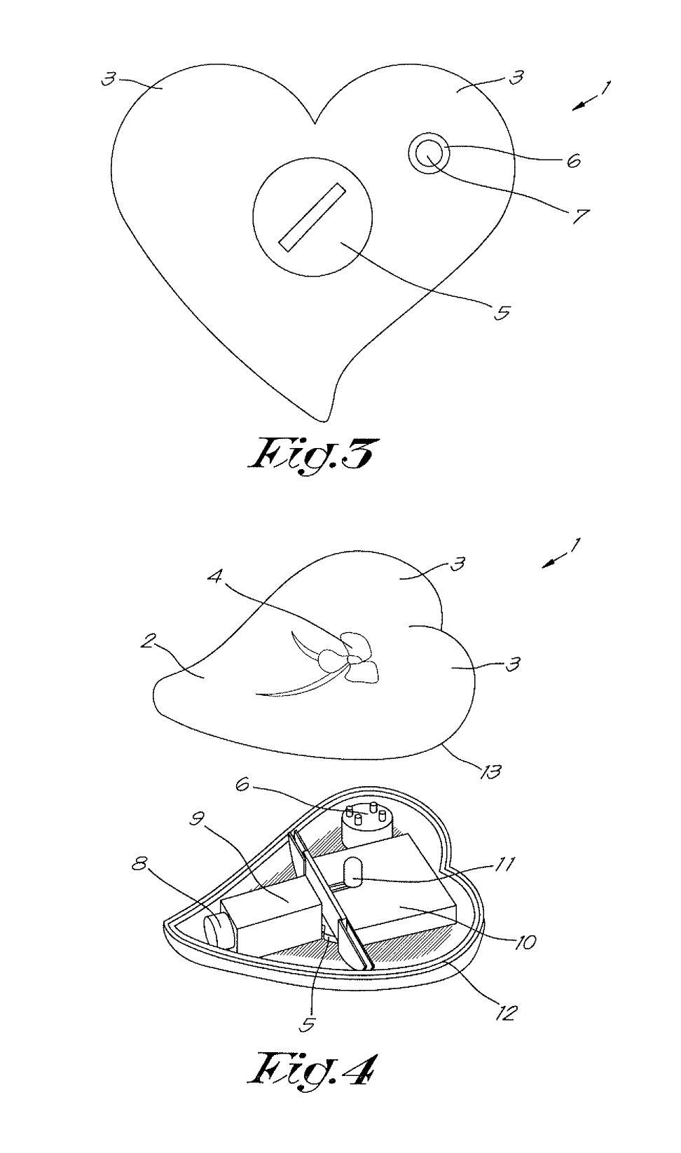

FIG. 3 shows the back of FIG. 2;

FIG. 4 schematically shows in perspective an opened view of the components of FIG. 1;

FIG. 1 schematically shows an erotic toy 1 according to the invention, consisting of a waterproof but translucent housing 2 in the form of a heart with convex surfaces 3.

FIG. 2 shows the front of the erotic toy 1, that has heart shaped contours and is provided with an ornamental motif 4 in relief, in this case a flower motif.

FIG. 3 shows the back of the erotic toy 1, on which centrally there is a waterproof closable connector 5 for a USB cable and eccentrically there is an operating button 6 for starting the functions of the toy 1. The operating button 6 itself is provided with an indicator light 7.

FIG. 4 schematically shows in perspective an opened view of the components of the toy 1, whereby the built-in vibrator 8 with vibrator motor 9 and the built-in lighting 10 with LED light 11 can be seen, such as that built in between the bottom half 12 of the housing 2 and the top half 13 of the housing 2.

The operation of the toy 1 is very simple and as follows. The toy can be carried discretely as its shape conceals its function. By using the operating button 6 the lighting of the toy 1 can be switched on, whereby the built-in LED light(s) 11 is (are) switched on that light up the red coloured housing 2 from inside, whereby a red light source occurs that has an atmosphere-creating effect on the surrounds.

In the next position of the operating button 6 the light can be changed to a flashing light instead of continuous in order to obtain a different lighting effect.

Because the toy can float in water, it can lie in a bath filled with water without problems and nonetheless remain on the surface of the water.

In a subsequent position of the operating button 6 the vibrator can be switched on whereby a continuous vibration is transmitted to the housing 2. The ergonomic shape of the housing enables erogenous zones of the body to be stimulated with it.

In a further position of the operating button 6 the vibrator 8 can be switched on whereby a pulsed vibration is transmitted to the housing 2, whereby the pulse is a double pulse whose rhythm corresponds to the two heart sounds (diastolic and systolic) of a fictitious regular beating heart. The ergonomic shape of the housing 2 enables a stimulating effect to be exerted on the blood circulation in erogenous zones of the body, which results in an improved blood supply and enhanced erotic sensitivity.

All functions can be switched off with the operating button 6, such that the toy does not consume any more electricity.

If the built-in rechargeable batteries become discharged, they can be recharged by opening the watertight cover 12 of the connector on the back of the toy by turning it open with a coin. The connector for a USB cable can now be accessed and the connector can be connected by a USB cable to an external electricity source by connecting the USB connector on the cable to a USB port of a computer or to a USB port of a transformer that is connected to the public electricity grid, analogous to charging a mobile telephone.

After charging, the watertight cover 5 can be put back in place so that the housing is again waterproof and can float on water. The toy 1 can be used again until the batteries have to be charged up again.

The present invention is by no means limited to the embodiment described as an example and shown in the drawings, but an erotic toy according to the invention with a double pulsed vibration can be realised in all kinds of variants, without departing from the scope of the invention.

1. An erotic toy for stimulating erogenous zones of the body, consisting ofcomprising a hollow, waterproof housing in the shape of a heart with convex surfaces that floats in water, equipped with a vibrator and internal lighting whereby the vibrations of the vibrator can be continuous or pulsed.

2. The erotic toy according to claim 1, characterised in wherein the vibrations of the vibrator are pulsed with a double pulse, whose rhythm corresponds to the two heart sounds including diastolic and systolic of a fictitious regular beating heart.

3. The erotic toy according to claim 1, wherein the internal lighting is configured to be set to continuous or flashing.

4. The erotic toy according to claim 1, wherein the internal lighting includes one or more LED lights.

5. The erotic toy according to claim 1, wherein the hollow housing is a matt red coloured plastic that is translucent.

6. The erotic toy according to claim 1, further comprising a waterproof closable connector, to which a USB cable is configured to be connected whose USB connector can be connected to a USB port on a personal computer or another power source, such as a USB port on a transformer, that can be connected to the public electricity grid.
